(19) United States
(12) Patent Application Publication
(10) Pub. No.: US 2003/0115482 A1
(43) Pub. Date: Jun. 19, 2003

(54) Method and apparatus for network service

(76) Inventors: Masatoshi Takihiro, Yokohama (JP); Hiroaki Miyata, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/077,750

(22) Filed: Feb. 20, 2002

(30) Foreign Application Priority Data
Dec. 5, 2001 (JP) 2001-371940

(51) Int. Cl. H04L 9/00; G06F 15/16

(52) U.S. Cl. 713/201; 709/229

(57) ABSTRACT

The convenience of access control services which are provided as additional services other than a network connection service are enhanced. In compliance with a request for connection to a service network 22 (in FIG. 1) as has been made by a subscriber, a subscriber accommodation device 1 connects a corresponding one of subscribers' terminals 6a-6c and a server 41 or 42 in a server network 4 as is available to the subscriber, by a bridge connection or a router connection, thereby to construct a closed network. Besides, in compliance with a request for altering the setting of filter information as has been made by a subscriber, the subscriber accommodation device 1 alters packet filtering which is to be applied to IP packets that are exchanged between a corresponding one of the subscribers' terminals 6a-6c and the service network 22.

### BACKGROUND OF THE INVENTION

The present invention relates to a network connection apparatus which provides a network connection service for the Internet or the like, and more particularly to a network connection apparatus which can provide each individual service subscriber with a peculiar access control service as a service additional to the network connection service.

In recent years, ISPs (Internet Service Providers) which render access control services as additional services other than an Internet connection service have increased in number. Here, typical as the access control services are, for example, a storage providing service and a packet filtering service. These services will be briefly explained below.

(1) Storage Providing Service (Storage Access Control Service)

This is a service in which a storage server for, for example, homepages is prepared, and service subscribers are authorized to use the server. Usually, the use of the storage server is granted to only those additional service subscribers of the service subscribers who can enjoy the storage providing service, so that an access control is performed by log-in authentication at a file access. By way of example, in a case where an FTP (RFC959, File Transfer Protocol) server is employed as the storage server, the log-in authentication is often executed at the file access by employing the authenticating function of FTP.

(2) Packet Filtering Service

This is a service in which packets to be transferred from a connection destination network, such as the Internet, to service subscribers are restrained. Only packets of an attribute permitted by each service subscriber are transferred from the network to the service subscriber, and any other packets are discarded. Thus, access from the connection destination network is controlled, and the network security of the service subscriber is protected.

### SUMMARY OF THE INVENTION

Problems as stated below are involved in the prior-art access control services which are provided as the additional services other than the network connection service.

(1) Storage Providing Service (Storage Access Control Service)

The storage server is managed on the side of the service provider. In order to suppress illegal accesses to the storage server, the service provider usually determines whether or not the use of the server is granted, by executing the log-in authentication at the file access. This signifies that even a legal additional service subscriber having a server using right needs to take a procedure for the authentication each time he/she uses the server. Such use of the server is inconvenient as compared with the use of a storage connected locally, or a storage server located in a LAN (Local Area Network) to which the additional service subscriber belongs.

(2) Packet Filtering Service

Setting for the packet filtering is requested of the service provider by the additional service subscriber. By way of example, using a terminal or the like, the additional service subscriber accesses a Web site provided by the service provider and requests the setting for the packet filtering. Upon receiving the request, the service provider performs the setting for the packet filtering, in a network connection apparatus in accordance with a content requested by the additional service subscriber. A time lag is therefore involved before the packet filtering is actually applied, since the setting for the packet filtering has been requested of the service provider by the additional service subscriber. Such setting is inconvenient as compared with packet filtering setting for a local or LAN-connected firewall. Moreover, in a case where the customized settings of the packet filtering are done for the individual additional service subscribers, increase in the number of the additional service subscribers increases a burden on the service provider accordingly.

The present invention has been made in view of the above circumstances, and it enhances the convenience of access control services which are provided as additional services other than a network connection service.

More concretely, the present invention permits a storage providing service to be provided as conveniently as in the case of using a storage connected locally or a storage server located in a LAN.

Besides, it permits a packet filtering service to be provided as conveniently as in the case of setting packet filtering for a local or LAN-connected firewall.

A network connection apparatus according to the present invention provides a terminal of each subscriber with a network connection service for connecting the terminal of the subscriber to a network, and an access control service being an additional service other than the network connection service. The apparatus comprises a subscriber information storage unit which stores subscriber information for authenticating each subscriber, together with access control information on the access control service available to the subscriber; a subscriber authentication unit which, upon accepting a request for connection to a first network from the terminal of the subscriber, authenticates the subscriber by reference to subscriber information obtained from the terminal, and the subscriber information stored in the subscriber information storage unit; and a service providing unit which connects the terminal of the subscriber authenticated by the subscriber authentication unit, to the first network, and which controls access to a predetermined node including the terminal of the subscriber, in accordance with the access control information stored in the subscriber information storage unit together with the subscriber information of the subscriber.

In the network connection apparatus of the present invention, owing to the above construction, any special procedure other than an authenticating procedure requested for the network connection service is not requested in order to enjoy the access control service which is the additional service other than the network connection service. Accordingly, the convenience of the access control service is enhanced.

By the way, in the present invention, the service providing unit may well perform a control in accordance with the access control information stored in the subscriber information storage unit, so that a predetermined server which belongs to a second network different from the first network may be accessed by only the terminal of the subscriber, thereby to construct a closed network which includes the predetermined server and the terminal of the subscriber.

By way of example, in a case where the second network, and a third network to which the terminal of the subscriber belongs are Ethernets each of which is standardized in IEEE802.3 (“Ethernet” is a trademark of Xerox Corporation), the service providing unit may perform a bridge connection between the terminal of the subscriber and the predetermined server, thereby to construct the closed network which includes the predetermined server and the terminal of the subscriber. Besides, in a case where the second network, and a third network to which the terminal of the subscriber belongs are IP (Internet Protocol) networks, the service providing unit may perform a router connection between the terminal of the subscriber and the predetermined server, thereby to construct the closed network which includes the predetermined server and the terminal of the subscriber.

In this way, the predetermined server can be used as conveniently as in the case of using a storage connected locally or a storage server located in the LAN of the subscriber himself/herself.

Besides, in the present invention, the service providing unit may perform packet filtering for packets which are exchanged between the first network and the terminal of the subscriber, in accordance with the access control information stored in the subscriber information storage unit. In this case, the network connection apparatus may further comprise a setting acceptance unit which accepts the access control information from the terminal of the subscriber authenticated by the subscriber authentication unit, and which stores the accepted information in the subscriber information storage unit together with the subscriber information of the subscriber.

In this way, the packet filtering can be set as conveniently as in the case of setting packet filtering for a local or LAN-connected firewall.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a schematic diagram of a network connection service system in which an embodiment of the present invention is provided;

FIGS. 2A-2C are diagrams for explaining logical lines which are established by PPP and VLAN;

FIG. 3 is a block diagram of a subscriber accommodation device 1 shown in FIG. 1;

FIG. 4 is a diagram for explaining an example of the registered contents of a bridge/router identification information table 161 shown in FIG. 3;

FIG. 5 is a diagram for explaining an example of the registered contents of a bridge group information table 162 shown in FIG. 3;

FIG. 6 is a diagram for explaining an example of the registered contents of a routing information table 163 shown in FIG. 3;

FIG. 7 is a diagram for explaining an example of the registered contents of a filtering information table 164 shown in FIG. 3;

FIG. 8 is a diagram for explaining an example of the registered contents of a subscriber information table 143 shown in FIG. 3;

FIG. 9 is a flow chart for explaining an operation in the case where the subscriber accommodation device 1 provides an access terminal with an additional service as may be needed, together with a network connection service;

FIG. 10 is a diagram showing the construction of a closed network 51 of Ethernet based on a bridge connection;

FIG. 11 is a diagram for explaining the flow of information items which participate until the closed network 51 based on the Ethernet is constructed by the flow shown in FIG. 9;

FIG. 12 is a diagram showing the construction of a closed network 52 of an IP network based on a router connection;

FIG. 13 is a diagram for explaining the flow of information items which participate until the closed network 52 based on the IP network is constructed by the flow shown in FIG. 9;

FIG. 14 is a flow chart for explaining an operation in the case where the subscriber accommodation device 1 alters the contents of a packet filtering service in compliance with a request made by an access terminal;

FIG. 15 is a diagram showing an example of an acceptance screen which serves to accept filter information that are various setting information items for packet filtering, from a service subscriber who is the operator of the access terminal;

FIG. 16 is a diagram for explaining the packet filtering which is performed in the subscriber accommodation device 1; and

FIG. 17 is a diagram for explaining the flow of information items which participate until the set content of the packet filtering are altered by the flow shown in FIG. 14.

### PREFERRED EMBODIMENT OF THE INVENTION

An embodiment of the present invention will be described below.

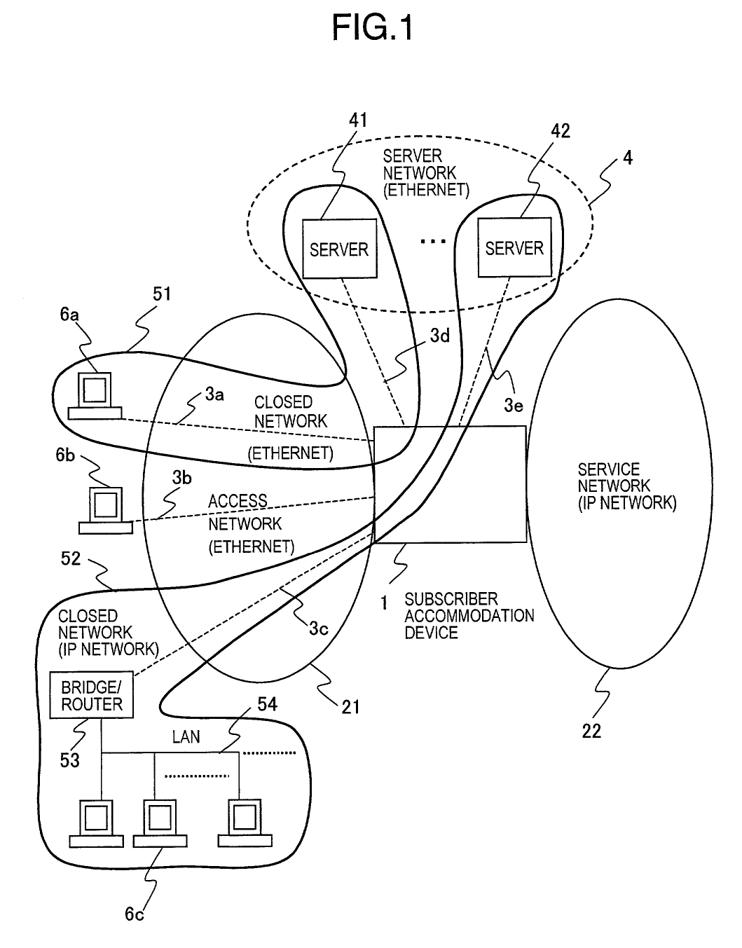

FIG. 1 is a schematic diagram of a network connection service system in which an embodiment of the present invention is provided.

Referring to FIG. 1, a subscriber accommodation device 1 is a network connection device which renders a service for connection to a service network 22. The subscriber accommodation device 1 accommodates subscribers' terminals 6a, 6b and a bridge/router 53 through an access network 21, and it renders a service (network connection service) for connecting the accommodated elements to the service network 22. Besides, it administers subscribers to whom the service was provided, by accounting dependent upon connection time periods or communication data traffics, and so forth.

In this embodiment, an IP network such as the Internet is supposed as the service network 22. Also, Ethernet standardized by IEEE802.3 is supposed as the access network 21. The subscriber accommodation device 1 connects the subscribers' terminals 6a, 6b and the bridge/router 53 by logical lines 3a-3c which are built on the Ethernet 21. Here, the bridge/router 53 is connected to a LAN 54 which includes a subscriber's terminal 6c.

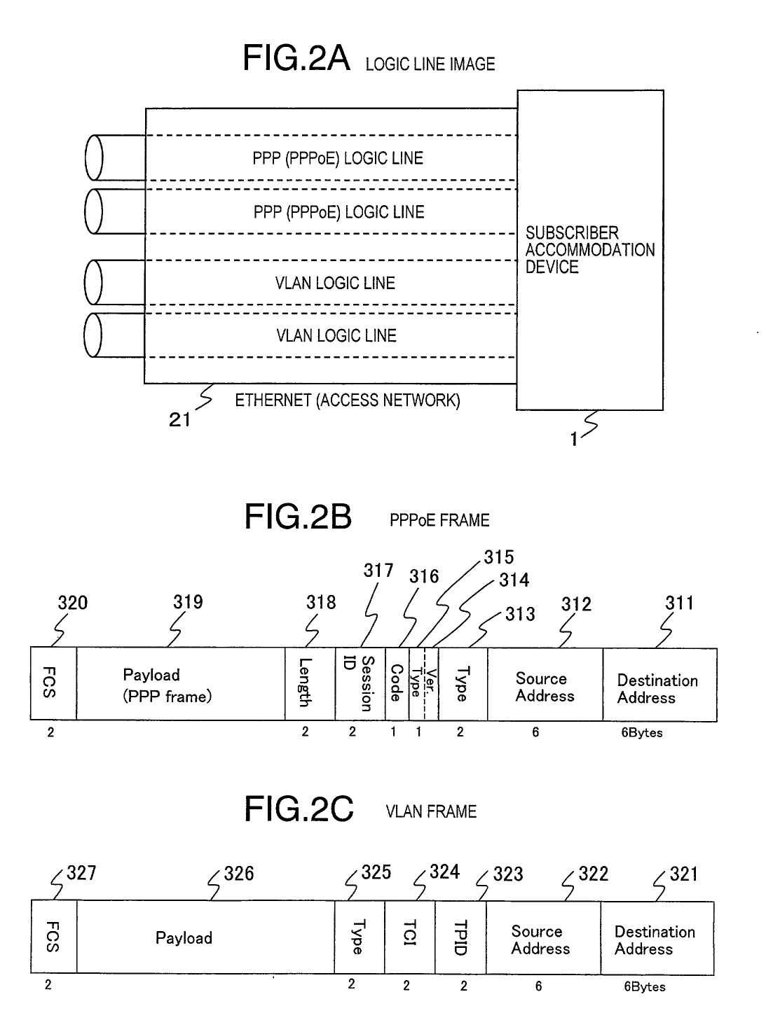

Incidentally, technologies for establishing logical lines are PPP (RFC1661 The Point-to-Point Protocol), VLAN (Virtual LAN) standardized by IEEE802.1Q, etc. The logical lines established by these technologies are shown in FIGS. 2A-2C.

FIG. 2A exemplifies a case where two logical channels based on the PPPoE (PPP over Ethernet) and two logical lines based on the VLAN are built on the Ethernet 21.

FIG. 2B shows the frame format of a PPPoE frame which is transmitted over the logical line established by the PPPoE. As shown in the figure, the PPPoE frame has as an Ethernet frame header, a destination address 311, a source address 312, and Type (0x8864) 313 which indicates that the content of the Ethernet frame is the PPPoE. Besides, the PPPoE frame has as a PPPoE header, Ver. (0x1) 314 and Type (0x1) 315 which indicate the version etc. of the PPPoE, version Code (0x00) 316 which indicates that the interior of a PPPoE packet is plain data, Session ID 317, and Length 318. The logical line is identified by a value which is stored in the Session ID 317. A PPP frame is stored in Payload 319. Further, the PPPoE frame has FCS (Frame Check Sequence) 320 as an Ethernet frame trailer.

FIG. 2C shows the frame format of a VLAN frame which is transmitted over the logical line established by the VLAN. As shown in the figure, the VLAN frame has as an extended Ethernet frame header prescribed by the IEEE802.1Q, a destination address 321, a source address 322, TP ID (Tag Protocol ID) 323, TCI (Tag Control Information) 324, and Type (0x8864) 325 which indicates that the content of the Ethernet frame is the VLAN. VLAN ID of 12 bits is stored in the TCI field 324, and the logical line is identified by the VLAN ID. An IP packet is included in Payload 326. Further, the VLAN frame has FCS 327 as an Ethernet frame trailer.

In addition, the subscriber accommodation device 1 is connected with a server network 4, and it renders a service (private server providing service) which authorizes the subscribers for the network connection service to privately use servers 41, 42 situated within the server network 4.

In this embodiment, Ethernet is supposed as the server network 4. The server network 4 needs not adjoin the subscriber accommodation device 1 geographically. It may well be a far network which is connected by a dedicated line or the like. The subscriber accommodation device 1 is connected with the servers 41, 42 on the server network 4 through logical lines 3d, 3e (technologies for establishing these logical lines are the same as in the case of the logical lines 3a-3c), and it connects to the servers 41, 42 the subscribers' terminals 6a, 6b and the bridge/router 53 which are connected to this subscriber accommodation device 1 through the access network 21. Thus, the device 1 constructs closed (private) networks and authorizes the network connection service subscribers to privately use the servers 41, 42.

Here, the “closed network” signifies a network which grants free communications between nodes (such as terminals and servers) belonging thereto, but which can restrain communications from any node not belonging thereto. In the example shown in FIG. 1, the subscriber accommodation device 1 constructs a closed network 51 including the subscriber's terminal 6a and the server 41, by the logical lines 3a, 3d. It also constructs a closed network 52 including the bridge/router 53 and the server 42, by the logical lines 3c, 3e. In this embodiment, the subscriber accommodation device 1 is capable of constructing the closed network by either Ethernet or an IP network. In the example shown in FIG. 1, the closed network 51 is constructed of the Ethernet, while the closed network 52 is constructed of the IP network.

Owing to the construction of the closed networks by the subscriber accommodation device 1, the subscribers for the network connection service can possess in the server network 4, the dedicated or private servers 41, 42 which are not accessed from any other nodes. Considered as the servers 41, 42 are data storage servers, servers for delivering contents such as videos or music, and so forth.

In addition, the subscriber accommodation device 1 renders a service (packet filtering service) which performs in case of the network connection service, packet filtering in accordance with set contents accepted from the terminals 6a-6c of the network connection service subscribers, so that only packets of attributes permitted by the set contents may be transferred from the service network 22 to the service subscribers' terminals 6a-6c, and that any other packets may be discarded.

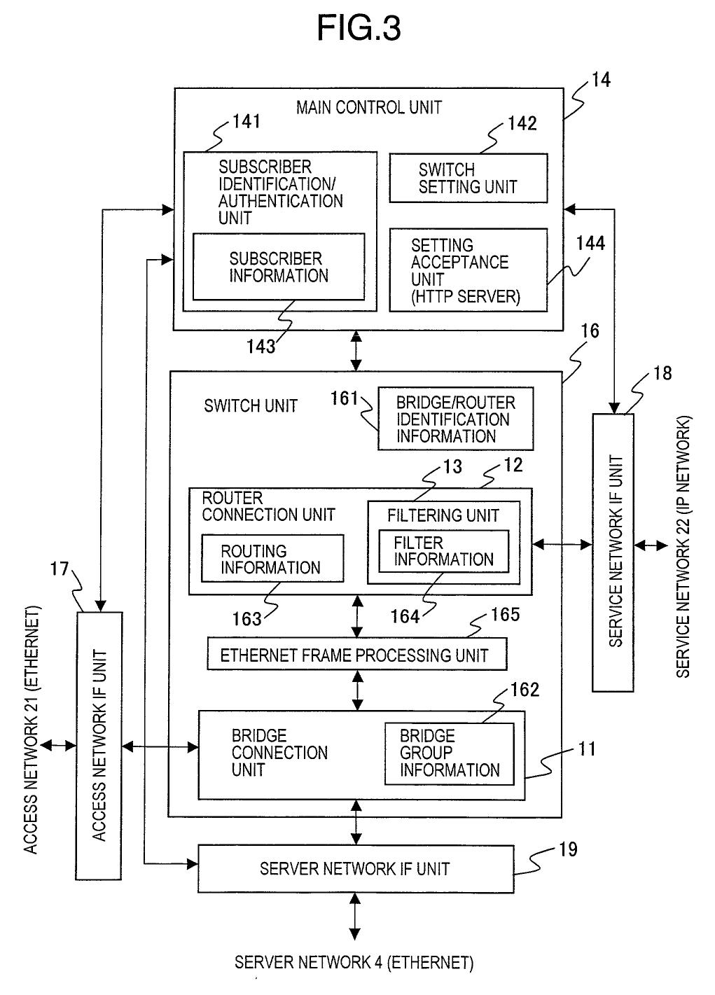

FIG. 3 is a block diagram of the subscriber accommodation device 1.

As shown in the figure, the subscriber accommodation device 1 includes an access network IF unit 17 for connecting the access network 21, a service network IF unit 18 for connecting the service network 22, a server network IF unit 19 for connecting the server network 4, a switch unit 16 which relays (exchanges) the individual IF units 17-19, and a main control unit 14 which generally controls units in the subscriber accommodation device 1.

The switch unit 16 includes a bridge connection unit 11 for establishing a bridge connection (connection at an Ethernet frame level), a router connection unit 12 for establishing a router connection (connection at an IP packet level), a bridge/router identification information table 161, and an Ethernet frame processing unit 165.

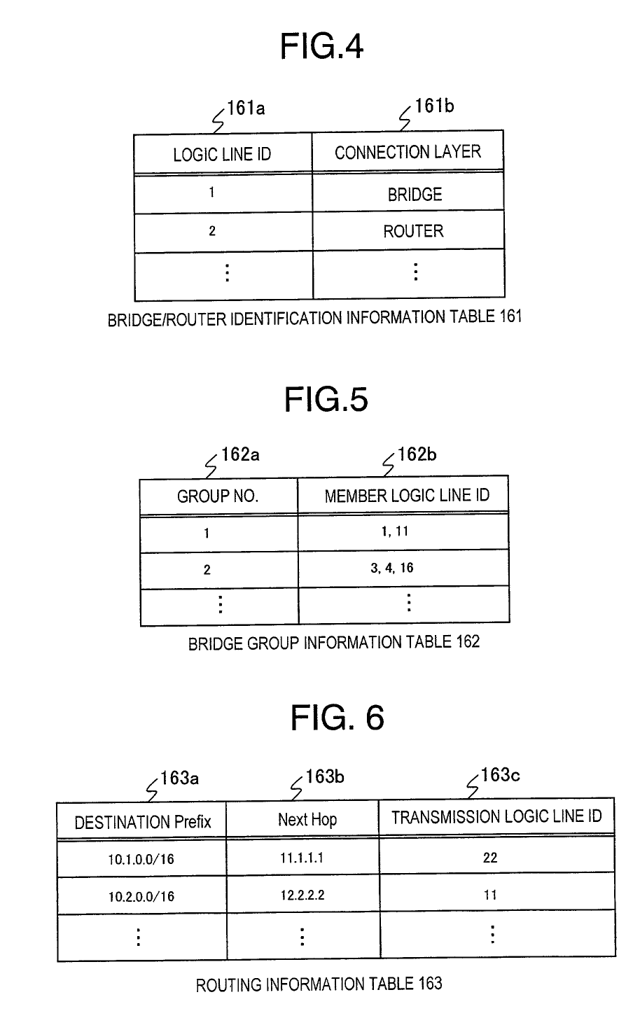

Registered contents in the bridge/router identification information table 161 is information items for managing whether each logical lines connected to the access network IF unit 17 and server network IF unit 19 are by the bridge connection or the router connection. FIG. 4 is a diagram for explaining an example of the registered contents of the bridge/router identification information table 161. In this example, a single record is formed including a field 161a for registering a logical line ID which is the identification information of the logical line, and a field 161b for registering a connection layer which indicates whether the logical line specified by the logical line ID is connected by the bridge connection or the router connection. Incidentally, a value stored in the Session ID 317 corresponds to the logical line ID in the case where the Ethernet frame to be transmitted over the logical line is the PPPoE frame, and a value stored in the TCI field 324 corresponds thereto in the case where the Ethernet frame to be transmitted over the logical line is the VLAN frame (refer to FIGS. 2B and 2C). Besides, in case of the connection layer of the bridge connection, a closed network to be constructed thereby becomes the Ethernet, whereas in case of the connection layer of the router connection, a closed network to be constructed thereby becomes the IP network.

The bridge connection unit 11 includes a bridge group information table 162. FIG. 5 is a diagram for explaining an example of the registered contents of the bridge group information table 162. In this example, a single record is formed including a field 162a for registering a group number which is uniquely allotted to the bridge connection, and a field 162b for registering member logical line IDs which are the logical line IDs of the logical lines to be connected by this bridge connection to each other (one another).

The bridge connection unit 11 performs the bridge connection the logical lines specified by the member logical line IDs registered in the field 162a, whereby the closed network based on the Ethernet is constructed for every record registered in the bridge group information table 162. Thus, nodes which are connected to the individual logical lines specified by the member logical line IDs registered in the field 162 a belong to an identical broadcast domain (a range in which broadcast packets are transmitted).

In order to realize the network connection service to the service network 22, however, the bridge connection unit 11 connects each of the logical lines connected to the access network IF unit 17, to the Ethernet frame processing unit 165.

The Ethernet frame processing unit 165 receives an Ethernet frame (PPPoE frame or VLAN frame) from the bridge connection unit 11, and it extracts an IP packet from the payload of the frame and delivers the IP packet to the router connection unit 12. On this occasion, it notifies also the logical line ID of the frame to the router connection unit 12. In addition, the Ethernet frame processing unit 165 receives an IP packet together with a logical line ID from the router connection unit 12. Besides, it creates an Ethernet frame (PPPoE frame or VLAN frame) toward the logical line ID, in which the IP packet is stored in its payload, and delivers the frame to the bridge connection unit 11.

The router connection unit 12 includes a routing information table 163, and a filtering unit 13 for packet filtering. Information for the routing process of an IP packet is registered in the routing information table 163. FIG. 6 is a diagram for explaining an example of the registered contents of the routing information table 163. In this example, a single record is formed including a field 163a for registering destination Prefix (destination IP address), a field 163b for registering Next HOP (IP address of a transfer destination node), and a field 163c for registering a transmission logical line ID which is the logical line ID of a logical line joined to the Next HOP.

The router connection unit 12 detects from the routing information table 163, a record as to which destination Prefix corresponding to the destination IP address of the IP packet received from the Ethernet frame processing unit 165 or the service network IF unit 18 is registered in the field 163a. Besides, it determines the transfer destination node of the IP packet in accordance with the contents registered in the fields 163b, 163c of the detected record. Subsequently, it sends the IP packet together with transfer destination node information onto a side where the transfer destination node exists. By way of example, if the transfer destination node is a node belonging to the access network 21 or the server network 4, the router connection unit 12 sends the IP packet to the Ethernet frame processing unit 165. On the other hand, if the transfer destination node is a node belonging to the service network 22, the router connection unit 12 sends the IP packet to the service network IF unit 18. Thus, the routing process of the IP packet is executed.

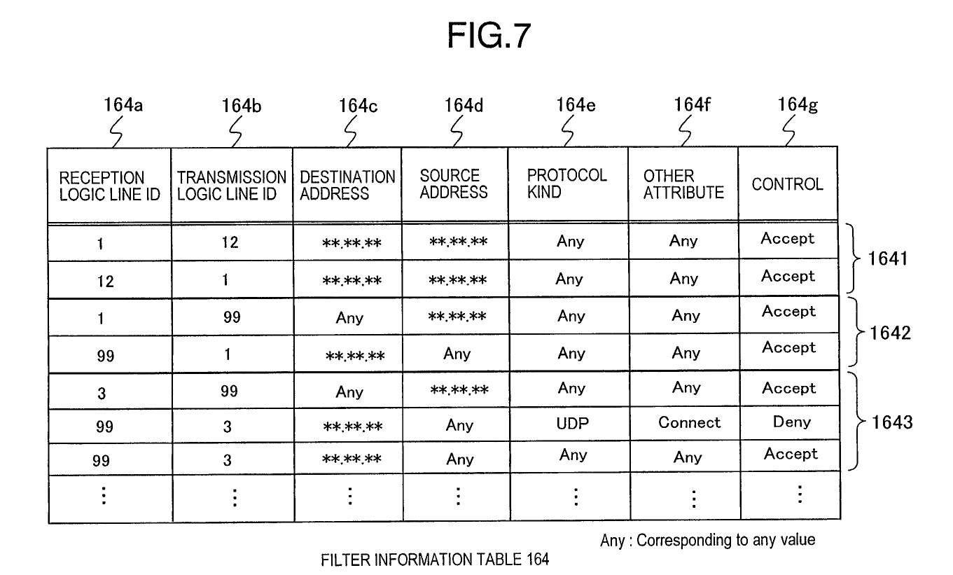

The filtering unit 13 has a filter information table 164. FIG. 7 is a diagram for explaining an example of the registered contents of the filtering information table 164. In this example, a single record is formed including a field 164a for registering a reception logical line ID which is the logical line ID of a logical line joined to a reception side node, a field 164b for registering a transmission logical line ID which is the logical line ID of a logical line joined to a transmission side node, a field 164c for registering a destination address, a field 164d for registering a source address, a field 164e for registering a protocol kind which is the kind of the upper layer of an IP packet, a field 164f for registering any other attribute which is the attribute information of the IP packet other than the information items registered in the fields 164a-164e, and a field 164g for registering a control rule which indicates whether the transfer of the IP packet satisfying the various conditions registered in the fields 164a-164f is accepted or denied.

The filtering unit 13 extracts from the filtering information table 164, a record whose conditions are satisfied by the IP packet having had its transfer destination determined by the routing process. Besides, it determines whether the transfer is accepted or denied, in accordance with a control rule registered in the field 164g of the extracted record. In case of accepting the transfer, the filtering unit 13 sends the IP packet to either of the Ethernet frame processing unit 165 (on condition that the transfer destination is the access network 21 or the server network 4) and the service network IF unit 18 (on condition that the transfer destination is the service network 22) in accordance with the transfer destination determined by the routing process. On the other hand, in case of denying the transfer, the filtering unit 13 discards the IP packet.

The main control unit 14 includes a subscriber identification/authentication unit 141, a switch setting unit 142, and a setting acceptance unit 144.

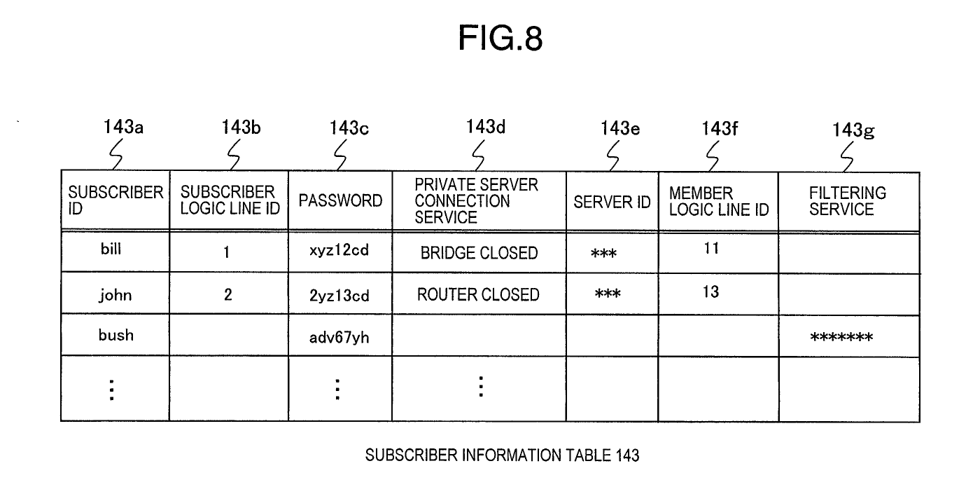

The subscriber identification/authentication unit 141 has a subscriber information table 143. FIG. 8 is a diagram for explaining an example of the registered contents of the subscriber information table 143. In this example, a single record is formed including a field 143a for registering a subscriber ID such as log-in name, a field 143b for registering a subscriber logical line ID which is the logical line ID of a logical line established between the subscriber identification/authentication unit 141 and the terminal of a subscriber, a field 143c for registering a password, a field 143d for registering the configuration of a closed network (either a closed network based on a bridge connection, or a closed network based on a router connection), the closed network being constructed for the private server providing service in a case where the subscriber has subscribed to this providing service, a field 143e for registering a server ID which is the identification information of a server that is to be available in the case where the subscriber has subscribed to the private server providing service, a field 143f for registering a member logical line ID which is the logical line ID of a logical line established between the subscriber identification/authentication unit 141 and the server specified by the server ID, and a field 143g for registering the set content of the packet filtering service in a case where the subscriber has subscribed to this packet filtering service. Here, the information items are set in the fields 143a, 143c, 143d, 143e and 143g beforehand, but the information items are registered in the fields 143b, 143f each time the logical lines are respectively established between the subscriber identification/authentication unit 141 and the terminal of the subscriber and between the subscriber identification/authentication unit 141 and the server.

When accessed from any of the subscribers' terminals 6a-6c through the access network IF unit 17, the subscriber identification/authentication unit 141 obtains a subscriber ID and a password from the terminal having made the access hereinbelow, termed “access terminal”). Besides, it detects from the subscriber information table 143, a record as to which the subscriber ID and the password obtained are respectively registered in the fields 143a, 143c. Thus, the subscriber is authenticated.

Further, if the authentication of the subscriber holds good, the subscriber identification/authentication unit 141 controls the access network IF unit 17 to establish a logical line between this access network IF unit 17 and the access terminal, and it registers the logical line ID of the established logical line in the field 143b of the detected record as a subscriber logical line ID. Besides, if a server ID is registered in the field 143e of the detected record, the subscriber identification/authentication unit 141 controls the server network IF unit 4 to establish a logical line between this server network IF unit 4 and the corresponding server, and it registers the logical line ID of the established logical line in the field 143f of the detected record as a member logical line ID.

The switch setting unit 142 updates the registered contents of the various information tables of the switch unit 16 on the basis of a record (termed “noticed record”) as to which the logical line IDs are respectively registered in the fields 143b, 143f of the subscriber information table 143.

Concretely, the switch setting unit 142 adds a record to the bridge/router identification information table 161 in correspondence with each of the logical line IDs registered in the fields 143b, 143f of the noticed record. Besides, it registers the logical line ID in the field 161a of the added record and registers the registered content of the field 143d of the noticed record in the field 161b.

Further, in the routing information table 163, the switch setting unit 142 registers the logical line ID registered in the field 143b of the noticed record, in the field 163c of a record as to which the address of the terminal of the subscriber is registered in the field 163a, and it registers the logical line ID stored in the field 143f of the noticed record, in the field 163c of a record as to which the address of the terminal of the server is registered in the field 163a.

Still further, if the registered content of the field 143d of the noticed record is a closed network based on a bridge connection, the switch setting unit 142 adds to the bridge group information table 162, a record as to which a unique group No. is registered in the field 162a. Besides, it registers the logical line IDs registered in the fields 143b, 143f of the noticed record, in the field 162b of the added record.

Yet further, if the registered content of the field 143d of the noticed record is a closed network based on a router connection, the switch setting unit 142 adds to the filter information table 164, a record owing to which the server specified by the server ID registered in the field 143e of the noticed record is permitted to transmit and receive IP packets to and from only the terminal of the subscriber specified by the subscriber ID registered in the field 143a of the noticed record.

Also, the switch setting unit 142 adds to the filter information table 164, a record owing to which the terminal of the subscriber specified by the subscriber ID registered in the field 143a of the noticed record is permitted to transmit and receive IP packets to and from the service network 22. On this occasion, if the set content of filtering is registered in the field 143g of the noticed record, the switch setting unit 142 creates a record owing to which the terminal of the subscriber is permitted to transmit and receive the IP packets to and from the service network 22 in accordance with the set content of the filtering.

The setting acceptance unit 144 has the function of, for example, an HTTP server, and it accepts the alteration content of the packet filtering service provided by the subscriber accommodation unit 1, from the access terminal authenticated as the subscriber.

Now, the operations of the subscriber accommodation device 1 of the above construction will be described.

First, there will be described the operation in the case where the subscriber accommodation device 1 provides an access terminal with an additional service (the private server providing service or the packet filtering service) as may be needed, together with the network connection service.

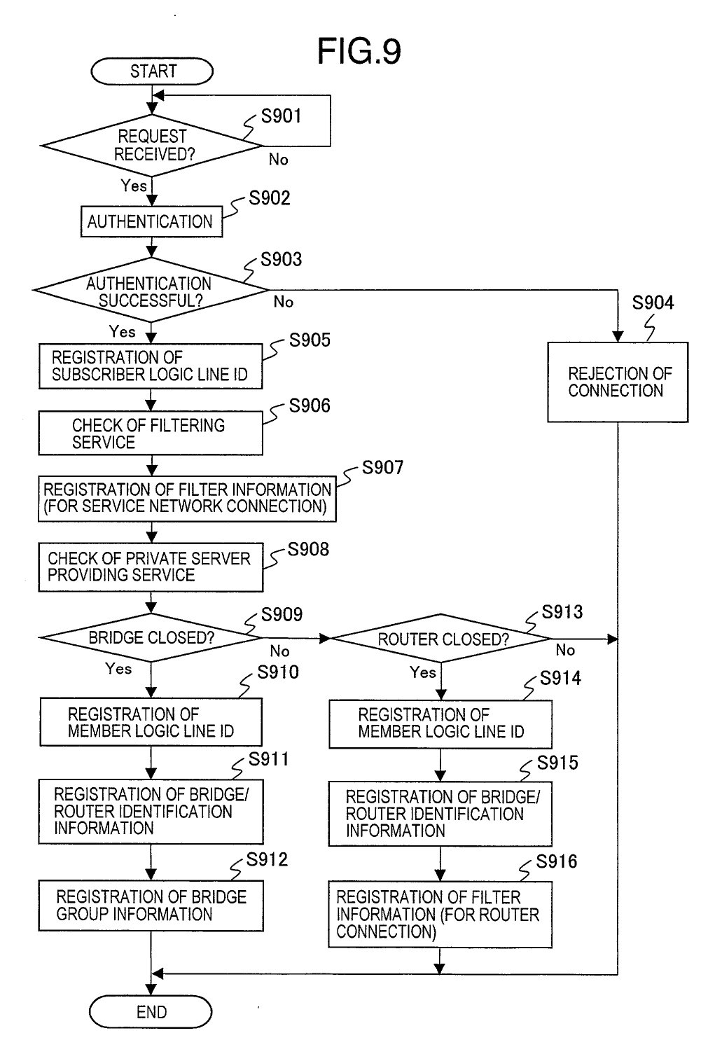

FIG. 9 is a flow chart for explaining the operation in the case where the subscriber accommodation device 1 provides the access terminal with the additional service as may be needed, together with the network connection service.

When the subscriber identification/authentication unit 141 of the main control unit 14 receives a connection request containing a subscriber ID and a password, from the access terminal through the access network IF unit 17 (S901), it authenticates the pertinent subscriber by verifying that a record as to which the subscriber ID and the password are respectively registered in the fields 143a, 143c is registered in the subscriber information table 143 (S902). Here, in a case where a logical line with the access terminal is to be established by a VLAN, the subscriber identification/authentication unit 141 can obtain the connection request from the access terminal by employing an authentication protocol prescribed in IEEE802.1x. Besides, in a case where a logical line with the access terminal is to be established by PPPoE, the subscriber identification/authentication unit 141 can obtain the connection request from the access terminal by employing an authentication protocol such as PAP (Password Authentication Protocol) or CHAP (Challenge Handshake Authentication Protocol).

In a case where the authentication of the subscriber has failed to hold good, that is, where the record (termed “subscriber record”) as to which the subscriber ID and the password contained in the received connection request are respectively registered in the fields 143a, 143c is not registered in the subscriber information table 143, the subscriber identification/authentication unit 141 rejects the connection of the access terminal and ends the operating process (S904).

On the other hand, in a case where the authentication of the subscriber has held good, that is, where the subscriber record is registered in the subscriber information table 143, the subscriber identification/authentication unit 141 controls the access network IF unit 17 to establish a logical line between it and the access terminal, and it registers the logical line ID of the logical line in the field 143b of the subscriber record as a subscriber logical line ID (S905). On this occasion, the subscriber identification/authentication unit 141 detects from the routing information table 163, a record as to which the address of the access terminal is registered in the field 163b, and it registers the logical line ID registered as the subscriber logical line ID, in the field 163c of the detected record.

Subsequently, the switch setting unit 142 checks the registered content of the field 143g of the subscriber record (S906). Unless any packet filtering set content is registered in the field 143g, the switch setting unit 142 creates a record which stipulates filter information for permitting the access terminal to transmit and receive all IP packets to and from the service network 22, and it registers the record in the filter information table 164. On the other hand, if a packet filtering set content is registered in the field 143g, the switch setting unit 142 creates a record which stipulates filter information for permitting the access terminal to transmit and receive IP packets to and from the service network 22 in accordance with the set content, and it registers the record in the filter information table 164 (S907).

Referring to FIG. 7, numeral 1642 designates an example of the record of filter information owing to which the terminal address of IP address “**.**.**” connected through the logical line of logical line ID “1” is permitted to transmit and receive all IP packets to and from the service network 22. Besides, numeral 1643 designates an example of the record of filter information owing to which the terminal address of IP address “**.**.**” connected through the logical line of logical line ID “3” is permitted to transmit and receive IP packets to and from the service network 22 except the reception of UDP packets. Here, logical line ID “99” is an ID which is fixedly allotted to a route to the service network 22 beforehand.

The router connection unit 12 determines the transfer destination node of the IP packets in accordance with the routing information registered in the routing information table 163, and it controls the relay of the IP packets to the transfer destination node in accordance with the filter information registered in the filter information table 164. Thus, the subscriber can enjoy the packet filtering service.

Subsequently, the switch setting unit 142 checks the registered content of the field 143d of the subscriber record (S908).

In a case where information which indicates a closed network based on a bridge connection is registered in the field 143d (S909), the switch setting unit 142 establishes a logical line between it and the server 41 or 42 specified by a server ID registered in the field 143e, and it registers the logical line ID of the logical line in the field 143f of the subscriber record as a member logical line ID (S910). On this occasion, the switch setting unit 142 detects from the routing information table 163, a record as to which the address of the specified server is registered in the field 163b, and it registers the logical line ID registered as the member logical line ID, in the field 163c of the record. Thereafter, the switch setting unit 142 registers in the bridge/router identification information table 161, a record as to which the logical line ID registered in the field 143b of the subscriber record is registered in the field 161a, while the information indicative of the bridge connection is registered in the field 161b (S911). Further, the switch setting unit 142 registers in the bridge group information table 162, a record as to which the logical line IDs registered in the fields 143b, 143f of the subscriber record are registered in the field 162b, while a unique group No. is registered in the field 162a (S912).

The bridge connection unit 11 performs a bridge connection between the logical lines in accordance with the information registered in the bridge group information table 162. Thus, the closed network of Ethernet based on the bridge connection, including the access terminal and the server, is constructed.

On the other hand, in a case where information which indicates a closed network based on a router connection is registered in the field 143d (S913), the switch setting unit 142 establishes a logical line between it and the server 41 or 42 specified by a server ID registered in the field 143e, and it registers the logical line ID of the logical line in the field 143f of the subscriber record as a member logical line ID (S914). On this occasion, the switch setting unit 142 detects from the routing information table 163, a record as to which the address of the specified server is registered in the field 163b, and it registers the logical line ID registered as the member logical line ID, in the field 163c of the record. Thereafter, the switch setting unit 142 registers in the bridge/router identification information table 161, a record as to which the logical line ID registered in the field 143b of the subscriber record is registered in the field 161a, while the information indicative of the router connection is registered in the field 161b (S915). Further, the switch setting unit 142 creates a record which stipulates filter information for permitting IP packets to be transmitted and received between the access terminal and the server specified by the server ID registered in the field 143e of the subscriber record, and it registers the filter information in the filter information table 164 (S916).

Referring to FIG. 7, numeral 1641 designates an example of the record of filter information owing to which the terminal address of IP address “**.**.**” connected through the logical line of logical line ID “1” is permitted to transmit and receive all IP packets to and from the server of IP address “**.**.**” connected through the logical line of logical line ID “12”.

The router connection unit 12 determines the transfer destination node of the IP packets in accordance with the routing information registered in the routing information table 163, and it controls the relay of the IP packets to the transfer destination node in accordance with the filter information registered in the filter information table 164. Thus, the closed network of an IP network based on the router connection, including the access terminal and the server, is constructed.

Next, the closed networks constructed by the flow shown in FIG. 9 will be described. First, the closed network of the Ethernet based on the bridge connection will be explained.

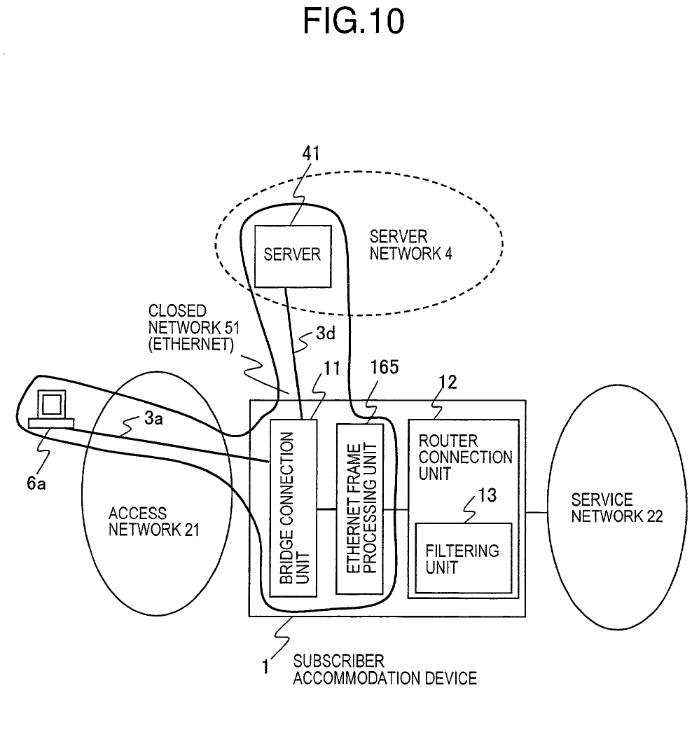

FIG. 10 shows the construction of the closed network 51 of the Ethernet based on the bridge connection. The subscriber's terminal 6a and the server 41 are respectively connected with the subscriber accommodation device 1 by the logical lines 3a, 3d. Besides, the bridge connection unit 11 of the subscriber accommodation device 1 performs a bridge connection between the logical line 3a, logical line 3d and Ethernet frame processing unit 165, whereby the closed network 51 of the Ethernet is constructed. On account of the bridge connection, the subscriber's terminal 6a and the server 41 can communicate with each other by operations similar to those in the case where they are connected to an identical LAN. That is, even when a host protocol is the peculiar protocol of a software vender used by the subscriber's terminal 6a, not TCP/IP employed in Internet communications, free communications are possible between the subscriber's terminal 6a and the server 41. Besides, free access to the server 41 can be granted to only the subscriber's terminal 6a in such a way that the transmission and reception of IP packets between the service network 22 and the server 41 are controlled in the filtering unit 13 of the router connection unit 12.

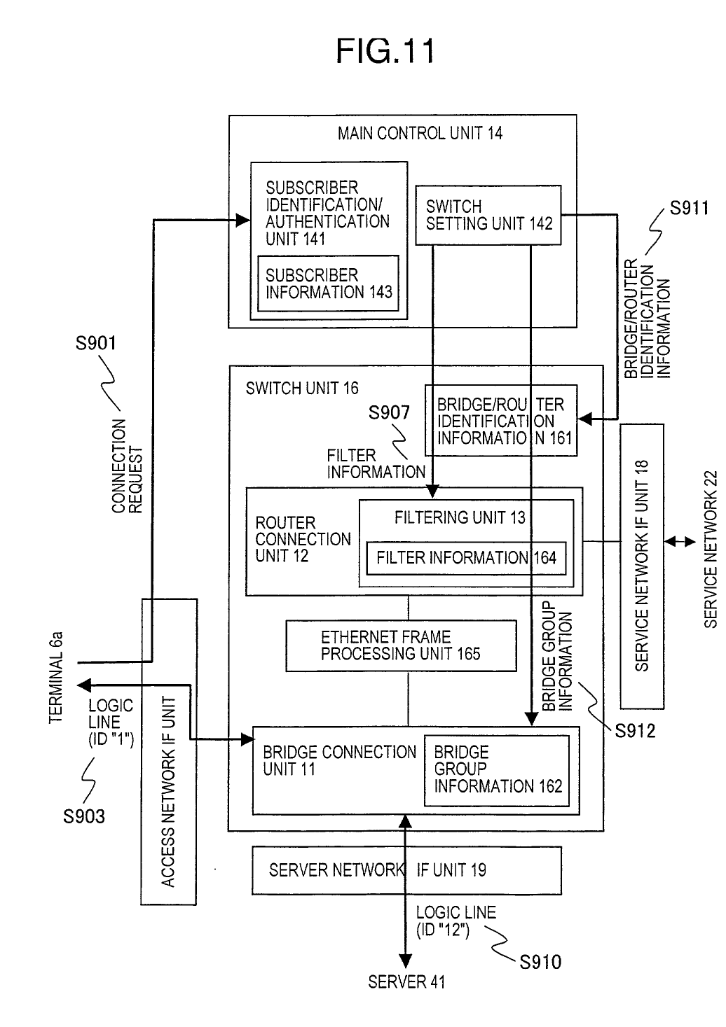

FIG. 11 is a diagram for explaining the flow of the information items which participate until the closed network 51 based on the Ethernet is constructed by the flow shown in FIG. 9. As stated above, when the subscriber identification/authentication unit 141 first receives the connection request from the subscriber's terminal 6a (S901), it authenticates the subscriber by reference to the subscriber information table 143. Besides, if the authentication has held good, the subscriber identification/authentication unit 141 establishes the logical line between it and the subscriber's terminal 6a, and it registers the corresponding logical line ID (“1” here) in the subscriber record of the subscriber information table 143 (S903). Subsequently, the switch setting unit 142 checks the filtering service by reference to the subscriber record, and it sets the filter information for using the service network 22, in the filter information table 164 in consideration of the checked result (S907). Thereafter, the switch setting unit 142 establishes the logical line between it and the server 41 specified by the server ID of the subscriber record, and it registers the corresponding logical line ID (“12” here) in the subscriber record of the subscriber information table 143 (S910). Also, the switch setting unit 142 registers the information items for permitting the server 41 to communicate with only the subscriber's terminal 6a, in the bridge/router identification information table 161 and the bridge group information table 162 (S911-S912). Thus, the bridge connection unit 11 performs a bridge connection between the logical line of the logical line ID “1” and that of the logical line ID “12”.

Next, the closed network of the IP network based on the router connection will be explained.

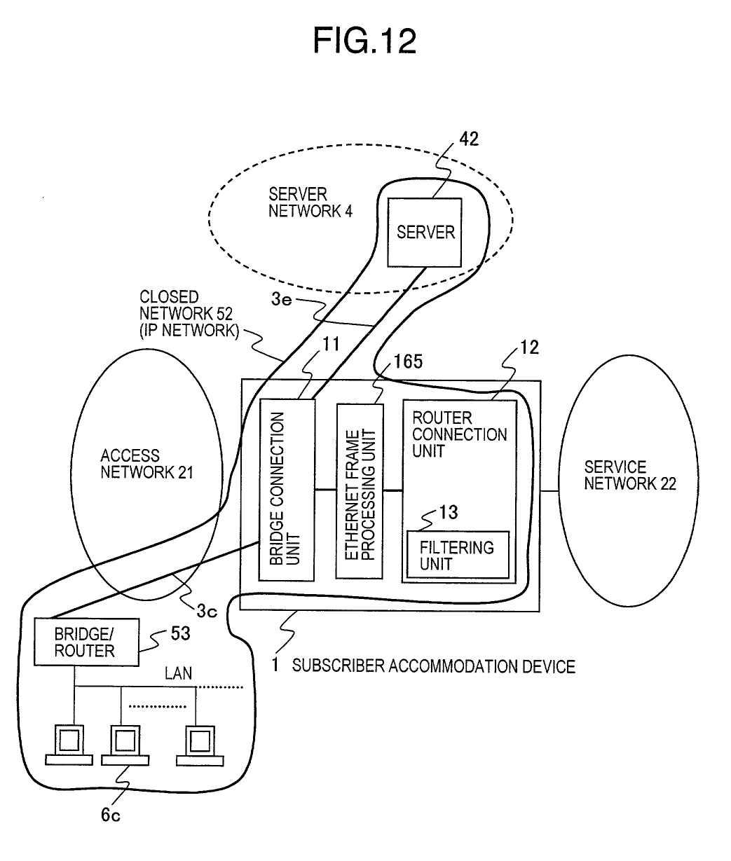

FIG. 12 shows the construction of the closed network 52 of the IP network based on the router connection. The bridge/router 53 to which the subscriber's terminal 6c is LAN-connected, and the server 42 are respectively connected with the subscriber accommodation device 1 by the logical lines 3c, 3e. Besides, the router connection unit 11 of the subscriber accommodation device 1 holds the router connection so that IP packets can be exchanged among the logical line 3c, logical line 3e and service network 22, whereby the closed network 52 of the IP network is constructed. On account of the router connection, the subscriber's terminal 6c and the server 42 can communicate with each other by using the IP packets. That is, free IP communications are possible between the subscriber's terminal 6c and the server 42. Besides, free access to the server 42 can be granted to only the subscriber's terminal 6c in such a way that the transmission and reception of the IP packets between the service network 22 and the server 42 are controlled in the filtering unit 13 of the router connection unit 12.

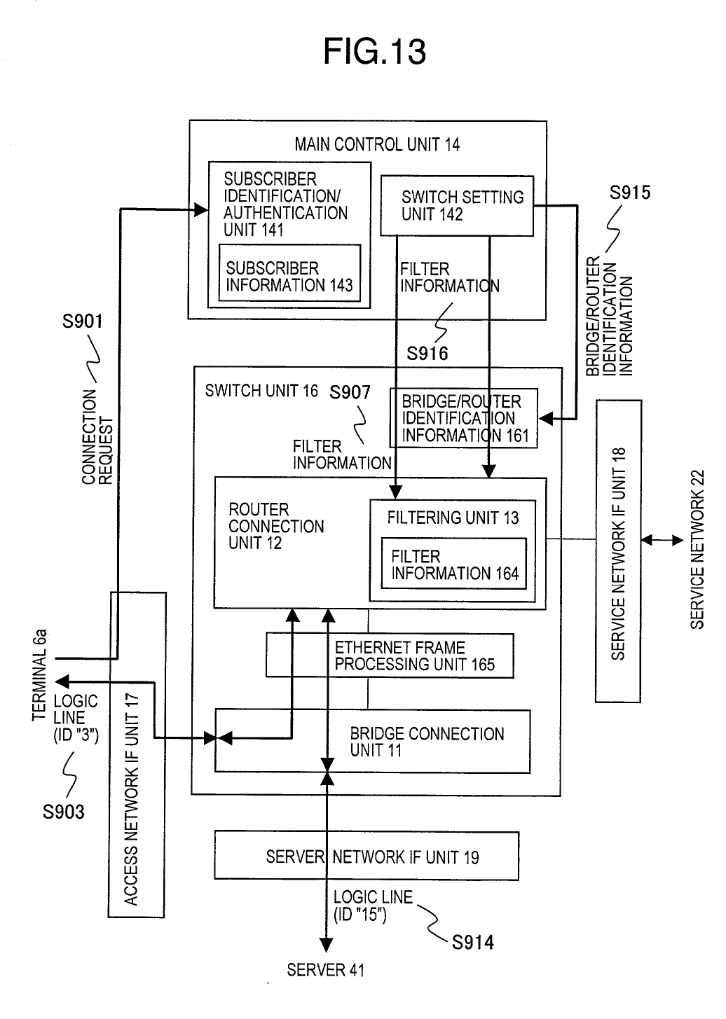

FIG. 13 is a diagram for explaining the flow of the information items which participate until the closed network 52 based on the IP network is constructed by the flow shown in FIG. 9. As stated above, when the subscriber identification/authentication unit 141 first receives the connection request from the bridge/router 53 to which the subscriber's terminal 6c is connected (S901), it authenticates the subscriber by reference to the subscriber information table 143. Besides, if the authentication has held good, the subscriber identification/authentication unit 141 establishes the logical line between it and the bridge/router 53, and it registers the corresponding logical line ID (“3” here) in the subscriber record of the subscriber information table 143 (S903). Subsequently, the switch setting unit 142 checks the filtering service by reference to the subscriber record, and it sets the filter information for using the service network 22, in the filter information table 164 in consideration of the checked result (S907). Thereafter, the switch setting unit 142 establishes the logical line between it and the server 42 specified by the server ID of the subscriber record, and it registers the corresponding logical line ID (“15” here) in the subscriber record of the subscriber information table 143 (S914). Also, the switch setting unit 142 registers the information items for permitting the server 42 to communicate with only the bridge/router 53, in the bridge/router identification information table 161 and the filter information table 164 (S915-S916). Thus, the router connection unit 12 performs a router connection between the logical line of the logical line ID “3” and that of the logical line ID “15”.

By the way, in the above description, on condition that the record of the corresponding filter information is registered in the filter information table 164 with respect to the IP packet whose transfer destination node has been determined, the filtering unit 13 executes the filtering of the IP packet in accordance with the filter information. In a case where the record of the corresponding filter information is not registered, the filtering unit 13 destroys the IP packet. However, in the case where the record of the corresponding filter information is not registered, the filtering unit 13 may well relay the IP packet to the transfer destination node without destroying it. Herein, in order to guarantee the free exchange of the IP packet inside only the closed network based on the router connection, it becomes necessary to register in the filter information table 164, a record which stipulates filter information for making the node inside the closed network incapable of exchanging the IP packet with any node outside the closed network (except any node inside the service network 22).

Thus far, there has been described the operation in the case where the subscriber accommodation device 1 provides the access terminal with the additional service as may be needed, together with the network connection service. Next, there will be described the operation in the case where the subscriber accommodation device 1 alters any content of the packet filtering service in compliance with a request made by an access terminal.

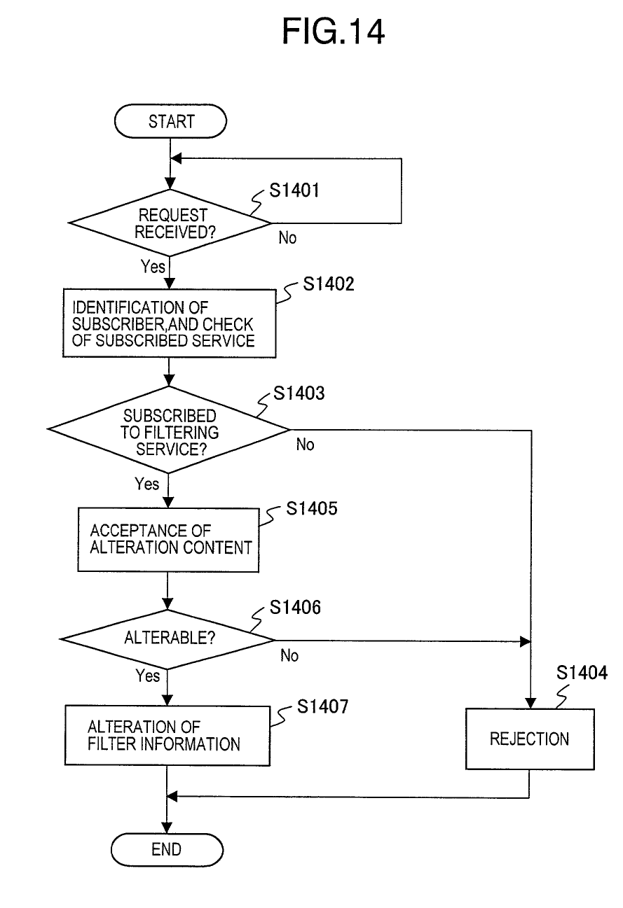

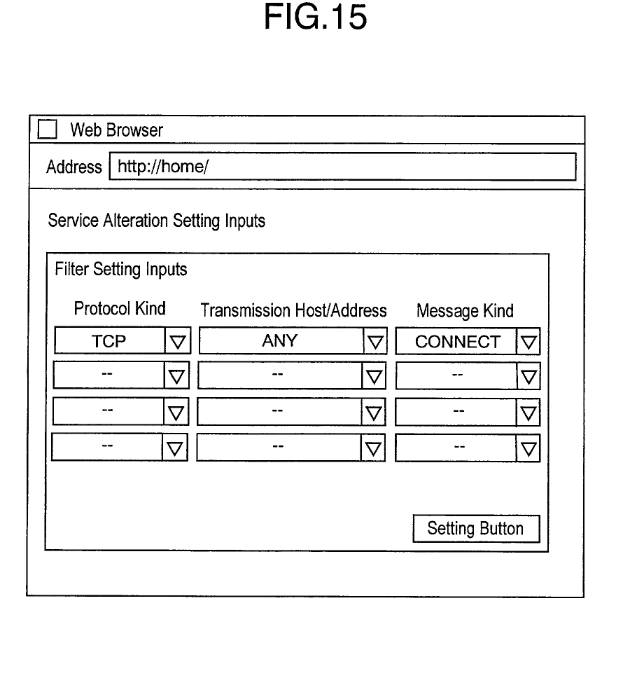

FIG. 14 is a flow chart for explaining the operation in the case where the subscriber accommodation device 1 alters the content of the packet filtering service in compliance with the request made by the access terminal. The flow is executed in a state where the authentication of the subscriber has held good by the flow shown in FIG. 9 and where the logical line has been established between the subscriber accommodation device 1 and the subscriber's terminal.

When the subscriber identification/authentication unit 141 of the main control unit 14 first receives a request for altering the setting of filter information, from the access terminal through the access network IF unit 17 and the switch unit 16 (S1401), it detects together with an IP packet storing the setting alteration request and from the subscriber information table 143, a record as to which the logical line ID of the logical line of the IP packet as has been notified by the switch unit 16 is registered in the field 143b. Thus, the unit 141 identifies the subscriber who requests the alteration of the setting of the filter information. Subsequently, the subscriber identification/authentication unit 141 checks the registered content of the field 143g of the extracted record, thereby to verify whether or not the subscriber has subscribed to the filtering service (S1402).

Subject to the resulting verification that the subscriber has not subscribed to the filtering service (S1403), the subscriber identification/authentication unit 141 rejects the setting alteration request from the access terminal and ends the operating process (S1404).

On the other hand, subject to the verification that the subscriber has subscribed to the filtering service (S1403), the unit 141 gives notice to that effect to the setting acceptance unit 144. Upon receiving the notice, the setting acceptance unit 144 transmits data for causing the access terminal to display an acceptance screen, through the switch unit 16 and the access network IF unit 17. As shown in FIG. 15 by way of example, the acceptance screen serves to accept filter information items being various setting information for the packet filtering, sent from the service subscriber who is the operator of the access terminal. Thereafter, the setting acceptance unit 144 obtains the filter information from the access terminal (S1405). Besides, the unit 144 delivers the obtained filter information to the switch setting unit 142.

The switch setting unit 142 verifies that the filter information delivered from the setting acceptance unit 144 relates to an IP packet in which the address of the access terminal is either of a transmission source and a transmission destination (S1406). In a case where the filter information does not relate to such an IP packet, the switch setting unit 142 rejects the setting alteration request from the access terminal and ends the operating process (S1404). On the other hand, in a case where the filter information relates to such an IP packet, the unit 142 registers or updates the filter information in the field 143g of a record corresponding to the subscriber of the access terminal, within the subscriber information table 143. Besides, the unit 142 updates the filter information table 164 so that the record correspondent to the filter information having been registered in the field 143g before the registration or updating may be altered to the record correspondent to the filter information registered in the field 143g after the registration or updating (S1407).

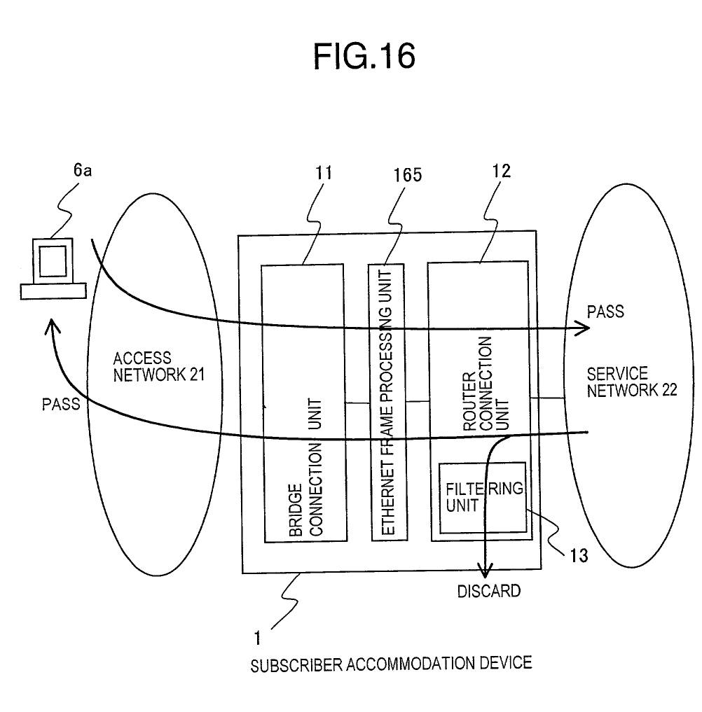

Next, there will be described the packet filtering which is performed in the subscriber accommodation device 1. FIG. 16 is a diagram for explaining the packet filtering which is performed in the subscriber accommodation device 1. As shown in the figure, the filtering unit 13 restrains the relay of IP packets between the service network 22 and the terminal of the subscriber who subscribes to the network connection service. In the illustrated example, some of the IP packets which are transferred from the service network 22 toward the subscriber's terminal 6a are discarded. Here, considered as the IP packets to be discarded are, for example, any IP packets which are other than ones concerning a TCP connection set in compliance with a subscriber's request. From the viewpoint of ensuring security, the filtering unit 13 usually grants only communications based on the TCP connection for which a connection setting request has been made by the subscriber. Besides, it is considered that, when any other communications are necessary, the filtering unit 13 makes a request for altering filter information so as to grant the communications.

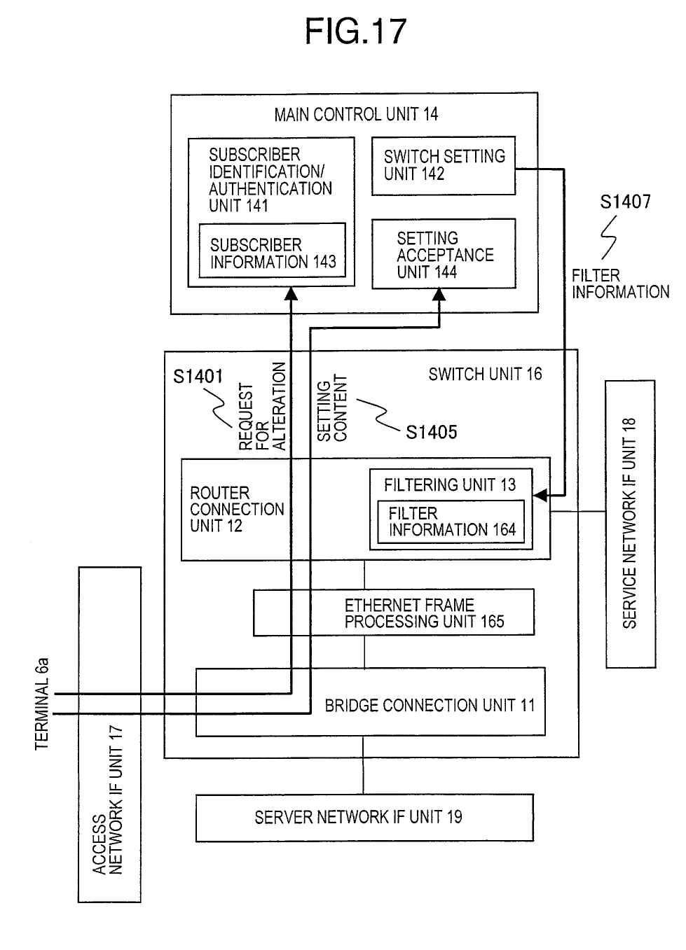

FIG. 17 is a diagram for explaining the flow of information items which participate until the set content of the packet filtering is altered by the flow shown in FIG. 14. As stated above, when the subscriber identification/authentication unit 141 first receives the request for altering the setting of filter information, from the subscriber's terminal 6a (S1401), it identifies the subscriber by reference to the subscriber information table 143 and verifies the subscription of the subscriber for the packet filtering service. Besides, After verification of the subscription of the subscriber for packet filtering service, the setting acceptance unit 144 accepts the setting information of the packet filtering from the subscriber's terminal 6a (S1405), and it reflects the accepted setting information in the filter information table 164 of the filtering unit 13 (S1407). Thus, the filtering unit 13 alters the rule of the packet filtering between the subscriber's terminal 6a and the service network 22.

Thus far, one embodiment of the present invention has been described.

In this embodiment, when a request for connection to a service network 22 is made by a subscriber, any of subscribers' terminals 6a-6c and a server 41 or 42 in a server network 4, available to the subscriber, are connected by a bridge connection or a router connection so as to construct a closed network. Accordingly, the subscriber can access the server 41 or 42 available to himself/herself within the server network 4, similarly to a server located in a LAN to which the subscriber belongs. Concretely, the authentication of the subscriber by the server is dispensed with at the server access. Thus, the subscriber can use the server which is as convenient as a server operated by each individual subscriber himself/herself, though he/she entrusts the server management of the file server (storage) or the like to the provider of a network connection service or a dealer operating the server network.

Besides, in this embodiment, the subscriber receiving the connection service of the service network 22 can immediately alter as may be needed, the setting information of packet filtering as is to be applied to IP packets which are exchanged between any of the subscribers' terminals 6a-6c and the service network 22. Thus, by way of example, only communications through a TCP connection set by the subscriber are granted as an initial state, and when any other communications have become necessary, a request for altering the setting of filter information is issued, thereby to permit the designated communications. Moreover, the setting of the packet filtering is done without the intervention of the administrator of a subscriber accommodation device 1, in other words, it is automated, so that the administrator can afford an added value to the network connection service without increasing an operating cost.

In this manner, according to this embodiment, the convenience of a private server providing service or a packet filtering service, which is provided as an additional service other than the network connection service, can be enhanced.

Incidentally, the present invention is not restricted to the foregoing embodiment, but it can be variously modified within the scope of the purport thereof.

By way of example, although a subscriber information table 143 is disposed in the subscriber accommodation device 1 in the embodiment, it can also be located in an external server. A RADIUS server can be employed as the external server. In this case, a subscriber identification/authentication unit 141 functions as a RADIUS client. In this way, the information items of the subscribers can be advantageously managed in centralized fashion.

Besides, the embodiment has been described by taking as an example a case where the closed network is constructed of Ethernet or an IP network as the private server providing service, but the present invention is not restricted thereto. By way of example, in a case where the closed networks are constructed on the basis of only the router connections, a data link layer being the lower layer of IP is not restricted to the Ethernet. Likewise, in a case where the closed networks are constructed on the basis of only the bridge connections, a network layer that is the upper layer of the Ethernet is not restricted to the IP.

Further, the embodiment has been described by taking as an example a system to which both the private server providing service and the packet filtering service can be applied as the services additional to the network connection service for the service network 22, but a system in the present invention may well be one to which only either of the private server providing service and the packet filtering service can be applied. Moreover, the additional services are not restricted to the private server providing service and the packet filtering service. The present invention is applicable to various access control services which require authentications when subscribers receive the services.

As described above, according to the present invention, the convenience of any access control service which is provided as an additional service other than a network connection service can be enhanced.

The specification and drawings are, accordingly, to be regarded in an illustrative rather than a restrictive sense. It will, however, be evident that various modifications and changes may be made thereto without departing from the broader spirit and scope of the invention as set forth in the claims.

What is claimed is:

1. A network connection apparatus which provides a terminal of each subscriber with a network connection service for connecting the terminal of the subscriber to a network, and an access control service that is an additional service other than the network connection service, comprising:
a subscriber information storage unit which stores subscriber information for authenticating each subscriber, together with access control information on the access control service available to the subscriber;
a subscriber authentication unit which, upon accepting a request for connection to a first network from the terminal of said subscriber, authenticates said subscriber by reference to subscriber information obtained from said terminal, and the subscriber information stored in said subscriber information storage unit; and
a service providing unit which connects said terminal of said subscriber authenticated by said subscriber authentication unit, to the first network, and which controls access to a predetermined node including said terminal of said subscriber, in accordance with the access control information stored in said subscriber information storage unit together with identification information of said subscriber.

2. A network connection apparatus according to claim 1, wherein:
said service providing unit performs a control in accordance with said access control information stored in said subscriber information storage unit, so that a predetermined server which belongs to a second network different from said first network may be accessed by only said terminal of said subscriber, thereby to construct a closed network which includes the predetermined server and said terminal of said subscriber.

3. A network connection apparatus according to claim 2, wherein:
the second network, and a third network to which said terminal of said subscriber belongs are Ethernets each of which is standardized in IEEE802.3; and
said service providing unit performs a bridge connection between said terminal of said subscriber and said predetermined server, thereby to construct the closed network which includes said predetermined server and said terminal of said subscriber.

4. A network connection apparatus according to claim 2, wherein:
the second network, and a third network to which said terminal of said subscriber belongs are IP (Internet Protocol) networks; and
said service providing unit performs a router connection between said terminal of said subscriber and said predetermined server, thereby to construct the closed network which includes said predetermined server and said terminal of said subscriber.

5. A network connection apparatus according to claim 1, wherein said service providing unit filters packets which are exchanged between said first network and said terminal of said subscriber, in accordance with said access control information stored in said subscriber information storage unit.

6. A network connection apparatus according to claim 5, further comprising a setting acceptance unit which accepts said access control information from said terminal of said subscriber authenticated by said subscriber authentication unit, and which stores the accepted information in said subscriber information storage unit together with said subscriber information of said subscriber.

7. A network connection method which provides a terminal of each subscriber with a network connection service for connecting the terminal of the subscriber to a network, and an access control service that is an additional service other than the network connection service, comprising:
the first step of accepting a request for connection to a first network from the terminal of each subscriber, and then authenticating the subscriber by reference to subscriber information obtained from said terminal, and subscriber information stored in a subscriber information storage unit; and
the second step of connecting said terminal of the authenticated subscriber to the first network, and controlling access to a predetermined node which includes said terminal of said subscriber, in accordance with access control information which is stored in the subscriber information storage unit together with identification information of said subscriber.

8. A network connection method according to claim 7, wherein said second step performs a control in accordance with said access control information stored in said subscriber information storage unit, so that a predetermined server which belongs to a second network different from said first network may be accessed by only said terminal of said subscriber, thereby to construct a closed network which includes the predetermined server and said terminal of said subscriber.

9. A network connection method according to claim 7, wherein said second step filters packets which are exchanged between said first network and said terminal of said subscriber, in accordance with said access control information stored in said subscriber information storage unit.

10. A network connection method according to claim 9, further comprising the third step of accepting said access control information from said terminal of the authenticated subscriber, and storing the accepted information in said subscriber information storage unit together with the subscriber information of said subscriber.
